(19) United States
(12) Patent Application Publication
(10) Pub. No.: US 2017/0163906 A1
(43) Pub. Date: Jun. 8, 2017

(54) Method for displaying multi-path videos on broadcast console and electronic apparatus for the same

(71) Applicants: Le Holdings (Beijing) Co., Ltd., Beijing (CN); LeCloud Computing Co., Ltd., Beijing (CN)

(72) Inventors: Xingyu Li, Beijing (CN); Maosheng Bai, Beijing (CN); Wei Wei, Beijing (CN)

(21) Appl. No.: 15/246,216

(22) Filed: Aug. 24, 2016

Related U.S. Application Data
(63) Continuation of application No. PCT/CN2016/088717, filed on Jul. 5, 2016.

(30) Foreign Application Priority Data
Dec. 7, 2015 (CN) 201510888429.3

(51) Int. Cl. H04N 5/262; H04N 21/234; H04N 21/2343; H04N 21/61

(52) U.S. Cl. CPC H04N 5/2628; H04N 21/6125; H04N 21/23418; H04N 21/234363

(57) ABSTRACT

The present application discloses a method for displaying multi-path videos on broadcast console and an electronic apparatus for the same. The method includes: obtaining plural first video signals in multi-path; determining a size and a displaying position of each of the first video signals according to a path quantity of the first video signals and a default resolution of a second video signal; transforming the size of each of the first video signals, and combining the first video signals into the second video signal in single path according to the displaying position; and outputting the second video signal to display equipment of the broadcast console and displaying the second video signal on the display equipment.

### CROSS REFERENCE TO RELATED APPLICATIONS

This application is a continuation of International Application No. PCT/CN2016/088717, filed on Jul. 5, 2016, which is based upon and claims priority to Chinese Patent Application No. 201510888429.3, filed on Dec. 7, 2015, the entire contents of which are incorporated herein by reference.

### TECHNICAL FIELD

The present disclosure relates to a field of network video, particular to a method for displaying multi-path videos on broadcast console and an electronic apparatus for the same.

### BACKGROUND

The broadcast console in the video industry is generally referred to the broadcast technique in the field of television program production. The broadcast console is mainly used to switch different sources of the videos so as to achieve the perfect display of the television program. For example, in a live program, there are multiple cameras facing towards different directions which send the video signals having images at different directions. The director will select to output the video signal in one of the paths according to the requirement.

Conventionally, in order to accomplish the display for multi-path video signals, plural display equipment may be necessary. If there are multi-path video signals simultaneously displayed on single display equipment, it is almost equivalent to that the video signals are simultaneously displayed by plural players in the single display equipment. Thus, the computing resources in the display equipment are overly consumed to cause overly high loading on the display equipment, and thereby the display of the video signals is failed or abnormal.

### SUMMARY

The application provides a method for displaying multi-path videos on broadcast console and device for the same. The method and the device are for solving the problems in the conventional technique when a display equipment of a broadcast console displays multi-path video signals with overly high loading.

To solve the problems in the conventional technique, the application discloses a method for displaying multi-path videos on a broadcast console, including:

Obtaining a plurality of first video signals in multi-path;

Determining a size and a displaying position of each of the plurality of first video signals according to a path quantity of the plurality of first video signals and a default resolution of a second video signal;

Transforming the size of each of the plurality of first video signals, and combining the plurality of first video signals into the second video signal in single path according to the displaying position; and

Outputting the second video signal to a display equipment of the broadcast console and displaying the second video signal on the display equipment.

The application also discloses a non-volatile computer storage medium storing a computer-executable instruction, and the computer-executable instruction is adapted for executing the method for displaying multi-path videos on the broadcast console in any one of the embodiments.

The application also discloses an electronic apparatus, including: at least one processor and a memory communicatively connected to the at least one processor. The memory stores an instruction executable by the at least one processor, and the at least one processor is adapted for calling the instruction to execute the method for displaying multi-path videos on the broadcast console in any one of the embodiments.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a technique flow chart of an embodiment of the disclosure;

FIG. 2 is a technique flow chart of another embodiment of the disclosure;

FIG. 3 is a technique flow chart of another embodiment of the disclosure;

FIG. 4 is a schematic view of a device of another embodiment of the disclosure; and

FIG. 5 is a schematic view of an electronic apparatus of another embodiment of the disclosure.

### DETAILED DESCRIPTION

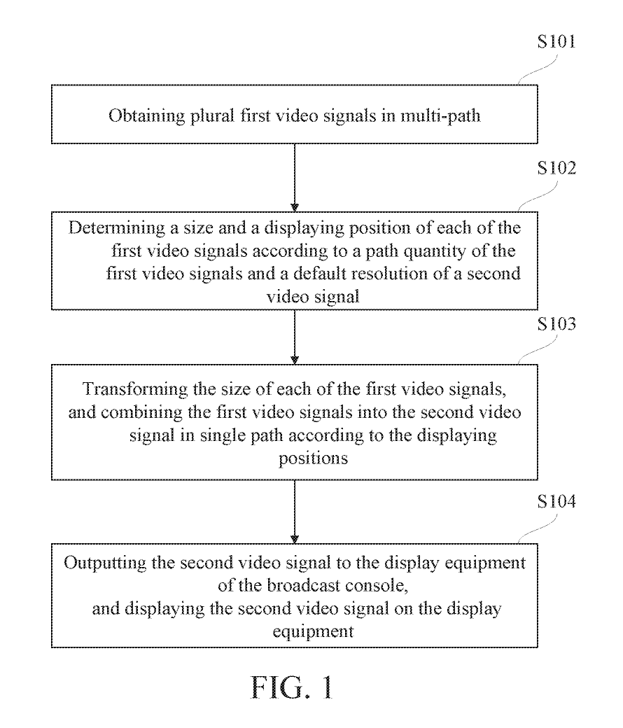

FIG. 1 is a technique flow chart of an embodiment of the present disclosure. The method disclosed in this embodiment is applicable to a server, and the server can be an equipment of a broadcast console for providing multi-path video signals. The method includes steps S101-S104.

In the step S101, obtaining plural first video signals in multi-path.

The first video signal can be a video signal from a live program or a recorded video signal. The multi-path first video signals are referred to input signals for the broadcast console to display and switch the image. For example, some images captured by plural cameras at different positions in the studio of the live program or the recorded program can be referred to the first video signals.

The URL address of each of the first video signals can be preset in the server, and the server can be a socket interface preset by a serving program of the broadcast console. The first video signals which respectively correspond to the URL addresses are obtained by transmission control protocol (TCP) or user datagram protocol (UDP).

In the step S102, determining a size and a displaying position of each of the first video signals according to a path quantity of the first video signals and a default resolution of a second video signal.

In this embodiment of the disclosure, after the multi-path first video signals are received by the server, the first video signals are combined to generate the second video signal in single path, and the second video signal is output to the broadcast console. Thus, it is necessary to preset the resolution, the video format and the data rate of the second video signal in the server.

In order to display the images of the multi-path first video signal in the one-path second video signal, the size and the displaying position of each of the first video signals should be determined. The size of the first video signal is the size of the image of the first video signal in the second video signal. The displaying position of the first video signal is the relative position of the image of the first video signal in the image of the second video signal.

The size and the displaying position of each of the second video signals are determined according to the path quantity of the first video signals and the default resolution of the second video signal. The image of the second video signal can be evenly divided according to the default resolution and the path quantity, and the sections of the divided second video signal are allocated to the first video signals; or alternatively, the first video signal having longer play time or important content can be displayed in the second video signal with longer displaying time or larger size such that it is favorable for the director to monitor. For example, one video signal including the image of the center of a conference hall, a square or a gym is more important than the other video signals such that the one video signal can be displayed in the second video signal with larger size for the director to monitor.

For example, the default resolution of the second video signal is 1080×720, and the path quantity of the first video signals is four; thereby, the default resolution can be evenly distributed among the four first video signals. For example, each of the size of the first video signals can be 540×360; or alternatively, one of the first video signals having important content can have a size of 1080×360, and the rest of them each have a size of 360×360. The aforementioned size arrangement for the first video signals is exemplary description, and the present disclosure is not limited thereto.

After the sizes of the first video signals are determined, the displaying position of each of the first video signals is determined. The images of the first video signals can be distributed on the image of the second video signal, and the coordinate information shown on the upper left corner of the image of the first video signal represents the displaying position of the first video signal.

For example, the upper left corner of the image of the second video signal is the origin, and a pair of the coordinates of the origin is (0, 0). The default resolution of the second video signal is 1080×720, and each of the four first video signals has a size of 540×360. The four first video signals are respectively distributed on the upper left, the upper right, the lower left and the lower right of the image of the second video signal. In some embodiment, the first video signal in the first path is displayed on the upper left of the image of the second video signal, and a pair of the coordinates at the upper left of the image thereof is (0, 0); the first video signal in the second path is displayed on the upper right of the image of the second video signal, and a pair of the coordinates at the upper left of the image thereof is (540, 0); the first video signal in the third path is displayed on the lower left of the image of the second video signal, and a pair of the coordinates at the upper left of the image thereof is (0, 360); and the first video signal in the fourth path is displayed on the lower right of the image of the second video signal, and a pair of the coordinates at the upper left of the image thereof is (540, 360).

In the step S103, transforming the size of each of the first video signals, and combining the first video signals into the second video signal in single path according to the displaying positions.

The transformation from the original size of the first video signal into the size of the first video signal mentioned in the step S103 can be achieved by the following method.

First, the first video signal is decoded to obtain the YUV data of the first video signal. YUV is typically used as part of a color image pipeline for encoding a color image or video by Europe television system. The YUV is a color space used in the phase alteration line (PAL) and sequential colour a memoire (SECAM) composite color video standards. Wherein, luminance component is denoted by Y, the two chromatic difference components are respectively denoted by B-Y (that is, U) and R-Y (that is, V).

The resolution of the first video signal is adjusted by the scale filter of Fast Forward Mpeg (FFMPEG). For example, the original resolution of the first video signal is 1080×720, and the size should be transformed into 540×360 in the step S102. In such a case, the resolution is adjusted by the scale filter:

ffmpeg -i input.yuv -vf scale=540:360 output1.yuv; wherein, 540:360 represents the adjusted size, output1 represents the output corresponding to the first video signal in the first path, “.yuv” represents that the first video signal is converted to the YUV color space. The output corresponding to the first video signal in the first path whose size is adjusted also belongs to the YUV color space. When the adjusted size is smaller than the original resolution of the first video signal, it is almost equivalent to execute a compression process for the YUV data of each graphics output primitive.

After the size of each of the first video signal is adjusted, the multi-path first video signals are combined to generate the single path second video signal according to the displaying positions determined in the step S102 (i.e. the coordinate information shown on the upper left corner of the image). The first video signals, for example, can be combined by an overlay filter:

ffmpeg -i output.yuv -i output1 .yuv -filter_complex overlay=0:0 output.yuv;

ffmpeg -i output.yuv -i output2.mp4 -filter_complex overlay=540:0 output.yuv;

ffmpeg -i output.yuv -i output3.yuv -filter_complex overlay=0:360 output.yuv; and

ffmpeg -i output.yuv -i output4.yuv -filter_complex overlay=540:360 output.yuv;

The adjusted four first video signals output1 through output4 are combined into the second video signal output.yuv according to the displaying positions. Then, according to the business requirement, the output signal belonging to the YUV color space is transcoded to form needed video format such as mp4 and mkv.

When each of the first video signals is converted to the YUV color space, the sampling format may be different from each other after the first video signal is converted. In such a case, a YUV sampling format of the second video signal can be preset, such as 4:4:4, 4:2:1 and 4:2:0. Before the combination of the first video signals, each of the video signals is converted to the preset YUV sampling format to ensure normal display of the second video signal.

In the step S104, outputting the second video signal to the display equipment of the broadcast console, and displaying the second video signal on the display equipment.

The multi-path first video signals has been combined into the second video signal, such that the display equipment of the broadcast console can play the second video signal in which the multi-path first video signals are shown simultaneously.

In this embodiment, the multi-path first video signals are combined into the single path second video signal, such that the broadcast console is able to monitor plural video images by merely displaying a video signal. Therefore, it is favorable for effectively reducing the loading on the display equipment of the broadcast console, and the failure of the broadcast console due to overly high loading of the display equipment is prevented.

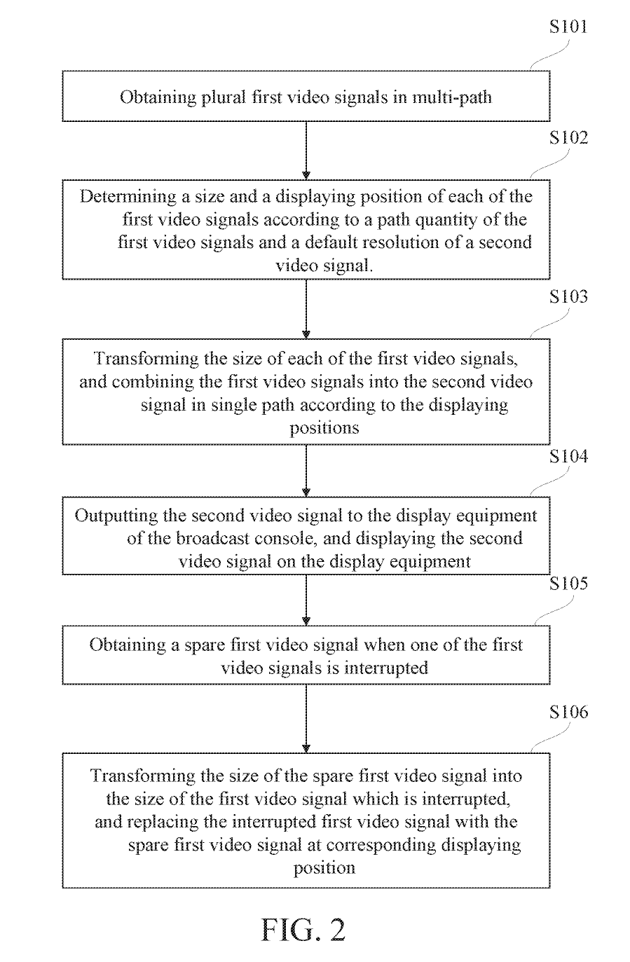

In another embodiment, as shown in FIG. 2, the method for displaying multi-path videos on the broadcast console further includes steps S105-S106.

In the step S105, obtaining a spare first video signal when one of the first video signals is interrupted.

The spare first video signal can be a video signal captured by other camera in the live program or the recorded program. Or alternatively, the spare first video signal can be a video signal saved in the server.

The URL address corresponding to the spare first video signal is preset, and a request for the spare first video signal is generated when the currently displayed first video signal is detect to be interrupted.

In the step S106, transforming the size of the spare first video signal into the size of the first video signal which is interrupted, and replacing the interrupted first video signal with the spare first video signal at corresponding displaying position.

By the process same as the step S103, the size of the spare first video signal is transformed into the size of the interrupted first video signal, and then the spare first video signal is combined with other non-interrupted first video signals into the second video signal. The first video signals can be synchronized by its timestamps, such that the interrupted first video signal is replaced with the spare first video signal.

In this embodiment, when one of the first video signals is interrupted, the spare first video signal is used to replace the interrupted first video signal automatically, especially when the major image, such as the image of the center of the conference hall, the square or the gym, is interrupted. Thus, it is favorable for preventing user experience from being influenced by unclear and black image when the director does not switch the video image immediately. When the first video signal corresponding to the major image is recovered, the spare first video signal is interrupted, and the spare first video signal is replaced with the recovered first video signal by the same steps.

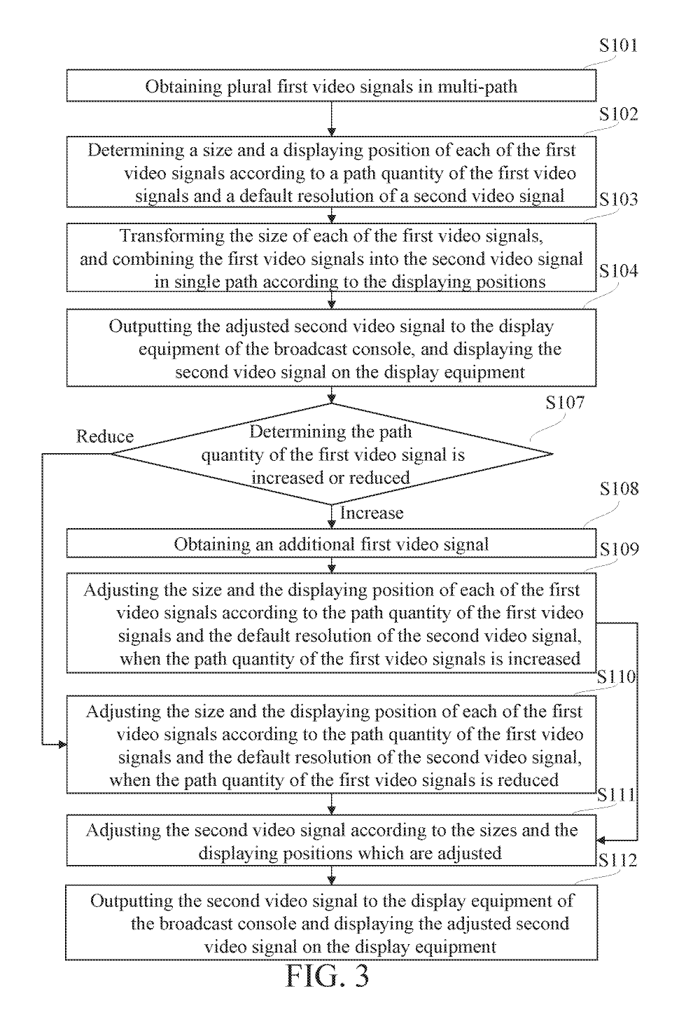

In another embodiment, as shown in FIG. 3, the method for displaying multi-path videos on the broadcast console further includes steps S107-S112.

In the step S107, determining the path quantity of the first video signal is increased or reduced. When the path quantity is increased, the step S108 is executed; when the path quantity is reduced, the step S110 is executed.

In the step S108, obtaining an additional first video signal.

In the step S109, adjusting the size and the displaying position of each of the first video signals according to the path quantity of the first video signals and the default resolution of the second video signal, when the path quantity of the first video signals is increased.

In the step S110, adjusting the size and the displaying position of each of the first video signals according to the path quantity of the first video signals and the default resolution of the second video signal, when the path quantity of the first video signals is reduced.

In the step S111, adjusting the second video signal according to the sizes and the displaying positions which are adjusted.

In the step S112, outputting the adjusted second video signal to the display equipment of the broadcast console and displaying the adjusted second video signal on the display equipment.

The quantity of the first video signals can be controlled by the broadcast console. The broadcast operator decides to increase or reduce the first video signals which should be simultaneously monitored, and also decides which one of the first video signals should be added or removed. After the server receives an instruction for increasing or reducing the first video signals, the URL address of the requested first video signal is added or removed. According to the change of the quantity of the URL addresses, the path quantity of the first video signal is determined to be increased or reduced.

If the path quantity of the first video signals is determined to be increased, the size and the displaying position of each first video signal are re-determined according to the increased path quantity. For example, after the path quantity of the first video signals is increased from four to five, the default resolution 1080×720 of the second video signal is distributed among the five first video signals, wherein three of the five first video signals has a size of 360×360, and the displaying positions are (0, 0), (360, 0) and (720, 0), respectively; The other two of the five first video signals has a size of 540×360, and the displaying positions are (0, 360) and (540, 360), respectively.

If the path quantity of the first video signals is determined to be reduced, the size and the displaying position of each first video signal are re-determined according to the reduced path quantity. For example, after the path quantity of the first video signals is reduced from four to three, the default resolution 1080×720 of the second video signal is distributed among the three first video signals, wherein two of the three first video signals has a size of 540×360, and the displaying positions are (0, 0) and (540, 0), respectively. The other one of the three first video signals has a size of 1080×360, and the displaying position is (0, 360).

The aforementioned path quantity of the first video signals and the steps for adjusting the size and the displaying position are only exemplary, and the present disclosure is not limited thereto.

The first video signals with adjusted sizes and displaying positions are combined to generate a new second video signal, and the new second video signal is output to the display equipment of the broadcast console to be displayed.

In this embodiment, with the change of the path quantity of the first video signals, each first video signal changes its size and displaying position, and the images displayed by the broadcast console are also adjusted jointly. When the path quantity of the first video signals is increased or reduced, it is unnecessary to restart the serving program, such that a free adjustment for the multi-path images on the broadcast console is achievable to improve the convenience of the operation on the broadcast console.

The following is a device according to another embodiment of the present disclosure, and the device is adapted for executing the method disclosed in the aforementioned embodiments of the present disclosure.

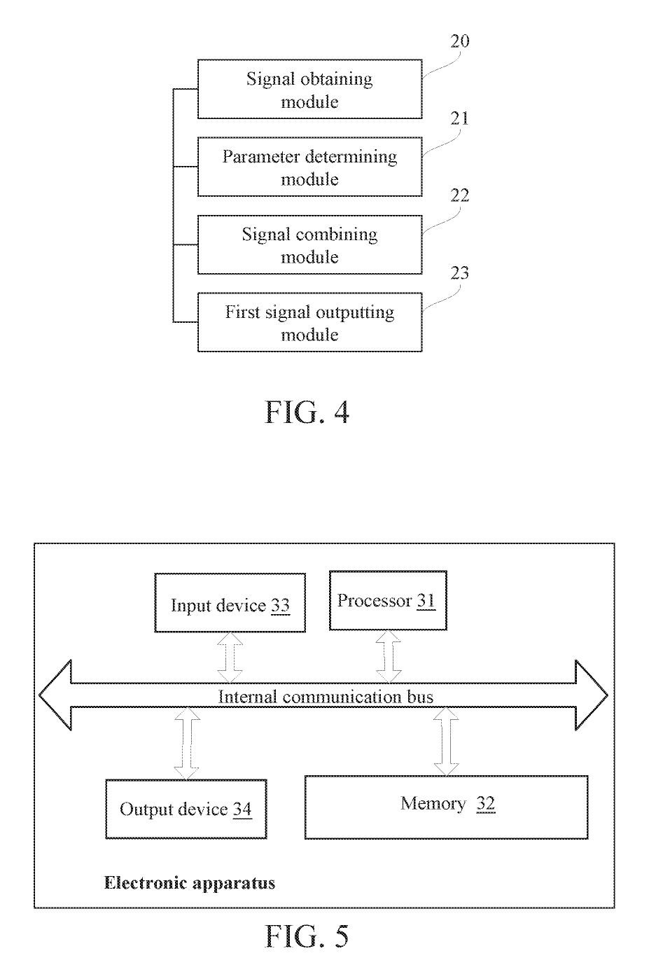

FIG. 4 is a schematic view of a device of another embodiment of the disclosure, wherein the device is located on the server side and includes:

A signal obtaining module 20 for obtaining plural first video signals in multi-path;

A parameter determining module 21 for determining a size and a displaying position of each of the first video signals according to a path quantity of the first video signals and a default resolution of a second video signal;

A signal combining module 22 for transforming the size of each of the first video signals, and combining the first video signals into the second video signal in single path according to the displaying position; and

A first signal outputting module 23 for outputting the second video signal to a display equipment of the broadcast console and displaying the second video signal on the display equipment.

In another embodiment, the device further includes:

A spare signal obtaining module for obtaining a spare first video signal when one of the first video signals is interrupted; and

A signal replacing module for transforming a size of the spare first video signal into the size of the interrupted first video signal, and replacing the interrupted first video signal with the spare first video signal at corresponding displaying position.

In another embodiment, the device further includes:

A signal increasing module for obtaining an additional first video signal, when the path quantity of the first video signals is increased;

A first parameter adjusting module for adjusting the size and the displaying position of each of the first video signals according to the path quantity of the first video signals and the default resolution of the second video signal, after the path quantity of the first video signals is increased;

A first signal adjusting module for adjusting the second video signal according to the sizes and the displaying positions which are adjusted; and

A second signal outputting module for outputting the adjusted second video signal to the display equipment of the broadcast console and displaying the adjusted second video signal on the display equipment.

In another embodiment, the device further includes:

A second parameter adjusting module for adjusting the size and the displaying position of each of the first video signals according to the path quantity of the first video signals and the default resolution of the second video signal, when the path quantity of the first video signals is reduced;

A second signal adjusting module for adjusting the second video signal according to the sizes and the displaying positions which are adjusted; and

A third signal outputting module for outputting the adjusted second video signal to the display equipment of the broadcast console and displaying the adjusted second video signal on the display equipment.

Furthermore, another embodiment of the present disclosure can accomplish the aforementioned functional modules by hardware processor.

Another embodiment of the present disclosure provides a non-volatile computer storage medium. The computer storage medium stores computer-executable instructions, and the computer-executable instructions can carry out the method for displaying multi-path videos on the broadcast console in any one of the embodiments.

Another embodiment of the present disclosure provides an electronic apparatus for displaying multi-path videos on the broadcast console. As shown in FIG. 5, the electronic apparatus is located on a side of the server and includes:

One or more processors 31 and a memory 32, and the processor 31 is one in quantity in FIG. 5.

The electronic apparatus for displaying multi-path videos on the broadcast console can include: an input device 33 and an output device 34.

The processor 31, the memory 32, the input device 33 and the output device 34 can be connected to each other via a bus or other members for electrical connection. In FIG. 5, they are connected to each other via the bus in this embodiment.

The memory 32 is one kind of non-volatile computer-readable storage mediums applicable to store non-volatile software programs, non-volatile computer-executable programs and modules, such as the program instructions and the function modules disclosed in this application (the signal obtaining module 20, the parameter determining module 21 and the signal combining module 22 in FIG. 4). The processor 31 executes function applications and data processing of the server by running the non-volatile software programs, the non-volatile computer-executable programs and modules stored in the memory 32, and thereby the methods for displaying multi-path videos on the broadcast console in the aforementioned embodiments are achievable.

The memory 32 can include a program storage area and a data storage area, wherein the program storage area can store an operating system and at least one application program required for a function; the data storage area can store the data created according to the usage of the device for displaying multi-path videos on the broadcast console. Furthermore, the memory 32 can include a high speed random-access memory, and further include a non-volatile memory such as at least one disk storage member, at least one flash memory member and other non-volatile solid state storage member. In some embodiments, the memory 32 can have a remote connection with the processor 31, and such memory can be connected to the device for controlling data rate of motion video by a network. The aforementioned network includes, but not limited to, internet, intranet, local area network, mobile communication network and combination thereof.

The input device 33 can receive digital or character information, and generate a key signal input corresponding to the user setting and the function control of the device for controlling data rate of motion video. The output device 34 can include a displaying unit such as screen.

The one or more modules are stored in the memory 32. When the one or more modules are executed by one or more processor 31, the method for displaying multi-path videos on the broadcast console disclosed in any one of the embodiments is performed.

The method provided in the embodiments, the function of each functional module and the relationships among the functional modules are all executable by the electronic apparatus. Any deficiencies in the illustration can be referred to the embodiments of the present disclosure.

The electronic apparatus in the embodiments of the present application is presence in many forms, and the electronic apparatus includes, but not limited to:

(1) Mobile communication apparatus: characteristics of this type of device are having the mobile communication function, and providing the voice and the data communications as the main target. This type of terminals include: smart phones (e.g. iPhone), multimedia phones, feature phones, and low-end mobile phones, etc.

(2) Ultra-mobile personal computer apparatus: this type of apparatus belongs to the category of personal computers, there are computing and processing capabilities, generally includes mobile Internet characteristic. This type of terminals include: PDA, MID and UMPC equipment, etc., such as iPad.

(3) Portable entertainment apparatus: this type of apparatus can display and play multimedia contents. This type of apparatus includes: audio, video player (e.g. iPod), handheld game console, e-books, as well as smart toys and portable vehicle-mounted navigation apparatus.

(4) Server: an apparatus provide computing service, the composition of the server includes processor, hard drive, memory, system bus, etc, the structure of the server is similar to the conventional computer, but providing a highly reliable service is required, therefore, the requirements on the processing power, stability, reliability, security, scalability, manageability, etc. are higher.

(5) Other electronic apparatus having a data exchange function.

The aforementioned embodiments are described for the purpose of explanation. The element for explanation can be a physical element or not; that is, the element for explanation can be located on a specific position or distrusted among plural network units. Many modifications and variations are possible in view of part or all of the above teachings, to thereby enable others skilled in the art to best utilize the disclosure and various embodiments with various modifications in order to suit to the particular use contemplated.

By the above described embodiment, those skilled in the art can understand that the present disclosure may be implemented by the computer readable storage medium which may include volatile and non-volatile, removable and non-removable media may be made in any method or technology to achieve information storage. Information can be computer readable instructions, data structures, program modules or other data. Examples of computer readable storage medium include, but are not limited to phase change memory (the PRAM), static random access memory (SRAM), dynamic random access memory (DRAM), other types of random access memory (RAM), read-only memory (ROM), electrically erasable programmable read-only memory (EEPROM), flash memory or other memory technology, CD-ROM read-only memory (CD-ROM), digital versatile disc (DVD) or other optical storage, magnetic tape cassette, magnetic disk storage or other magnetic tape storage mediums, or any other magnetic non-transmission medium, it may be used to store the information can be computing device access. Defined in accordance with this article, a computer-readable medium excluding non staging computer-readable media (transitory media), such as a modulated data signal and the carrier.

Although various embodiments of the present disclosure are described above with reference to figures, those skilled in the art would understand that the various embodiments of the present disclosure is made, may also departing from the present disclosure is not based on make a variety of improvements. Accordingly, the scope of the disclosure should be determined by the appended claims contents of the book claims.

What is claimed is:

1. A method for displaying multi-path videos on a broadcast console, applicable to server, comprising:
obtaining a plurality of first video signals in multi-path;
determining a size and a displaying position of each of the plurality of first video signals according to a path quantity of the plurality of first video signals and a default resolution of a second video signal;
transforming the size of each of the plurality of first video signals, and combining the plurality of first video signals into the second video signal in single path according to the displaying position; and
outputting the second video signal to a display equipment of the broadcast console and displaying the second video signal on the display equipment.

2. The method according to claim 1, wherein, the method further comprises:
obtaining a spare first video signal if one of the plurality of first video signals is interrupted; and
transforming a size of the spare first video signal into the size of the first video signal which is interrupted, and replacing the first video signal interrupted with the spare first video signal at corresponding displaying position.

3. The method according to claim 1, wherein, the method further comprises:
obtaining an additional first video signal, if the path quantity of the plurality of first video signals is increased;
adjusting the size and the displaying position of each of the plurality of first video signals according to the path quantity of the plurality of first video signals and the default resolution of the second video signal, which the path quantity of the plurality of first video signals is increased;
adjusting the second video signal according to the sizes and the displaying positions which are adjusted; and
outputting the second video signal which is adjusted to the display equipment of the broadcast console and displaying the second video signal on the display equipment.

4. The method according to claim 1, wherein, the method further comprises:
adjusting the size and the displaying position of each of the plurality of first video signals according to the path quantity of the plurality of first video signals and the default resolution of the second video signal, if the path quantity of the plurality of first video signals is reduced;
adjusting the second video signal according to the sizes and the displaying positions which are adjusted; and
outputting the second video signal which is adjusted to the display equipment of the broadcast console and displaying the second video signal on the display equipment.

5. A non-volatile computer storage medium storing a computer-executable instruction, and the computer-executable instruction being for:
obtaining a plurality of first video signals in multi-path;
determining a size and a displaying position of each of the plurality of first video signals according to a path quantity of the plurality of first video signals and a default resolution of a second video signal;
transforming the size of each of the plurality of first video signals, and combining the plurality of first video signals into the second video signal in single path according to the displaying position; and
outputting the second video signal to a display equipment of the broadcast console and displaying the second video signal on the display equipment.

6. An electronic apparatus, comprising:
at least one processor; and
a memory communicatively connected to the at least one processor, wherein the memory stores an instruction executable by the at least one processor, the at least one processor is for calling the instruction to execute a method comprising:
obtaining a plurality of first video signals in multi-path;
determining a size and a displaying position of each of the plurality of first video signals according to a path quantity of the plurality of first video signals and a default resolution of a second video signal;
transforming the size of each of the plurality of first video signals, and combining the plurality of first video signals into the second video signal in single path according to the displaying position; and
outputting the second video signal to a display equipment of the broadcast console and displaying the second video signal on the display equipment.

7. The non-volatile computer storage medium according to claim 5, wherein, the computer-executable instruction is further for:
obtaining a spare first video signal if one of the plurality of first video signals is interrupted; and
transforming a size of the spare first video signal into the size of the first video signal which is interrupted, and replacing the first video signal interrupted with the spare first video signal at corresponding displaying position.

8. The non-volatile computer storage medium according to claim 5, wherein, the computer-executable instruction is further for:
obtaining an additional first video signal, if the path quantity of the plurality of first video signals is increased;
adjusting the size and the displaying position of each of the plurality of first video signals according to the path quantity of the plurality of first video signals and the default resolution of the second video signal, if the path quantity of the plurality of first video signals is increased;
adjusting the second video signal according to the sizes and the displaying positions which are adjusted; and
outputting the second video signal which is adjusted to the display equipment of the broadcast console and displaying the second video signal on the display equipment.

9. The non-volatile computer storage medium according to claim 5, wherein, the computer-executable instruction is further for:
adjusting the size and the displaying position of each of the plurality of first video signals according to the path quantity of the plurality of first video signals and the default resolution of the second video signal, if the path quantity of the plurality of first video signals is reduced;
adjusting the second video signal according to the sizes and the displaying positions which are adjusted; and
outputting the second video signal which is adjusted to the display equipment of the broadcast console and displaying the second video signal on the display equipment.

10. The electronic apparatus according to claim 6, wherein, the instruction is called to execute the method further comprising:
obtaining a spare first video signal if one of the plurality of first video signals is interrupted; and
transforming a size of the spare first video signal into the size of the first video signal which is interrupted, and replacing the first video signal interrupted with the spare first video signal at corresponding displaying position.

11. The electronic apparatus according to claim 6, wherein, the instruction is called to execute the method further comprising:
obtaining an additional first video signal, if the path quantity of the plurality of first video signals is increased;
adjusting the size and the displaying position of each of the plurality of first video signals according to the path quantity of the plurality of first video signals and the default resolution of the second video signal, if the path quantity of the plurality of first video signals is increased;
adjusting the second video signal according to the sizes and the displaying positions which are adjusted; and
outputting the second video signal which is adjusted to the display equipment of the broadcast console and displaying the second video signal on the display equipment.

12. The electronic apparatus according to claim 6, wherein, the instruction is called to execute the method further comprising:
adjusting the size and the displaying position of each of the plurality of first video signals according to the path quantity of the plurality of first video signals and the default resolution of the second video signal, if the path quantity of the plurality of first video signals is reduced;
adjusting the second video signal according to the sizes and the displaying positions which are adjusted; and
outputting the second video signal which is adjusted to the display equipment of the broadcast console and displaying the second video signal on the display equipment.
